(19) United States
(12) Patent Application Publication
(10) Pub. No.: US 2003/0229614 A1
(43) Pub. Date: Dec. 11, 2003

(54) Hand-held data entry system and method for medical procedures

(76) Inventor: Howard S. Kotler, Chicago, IL (US)

Correspondence Address: Keith A. Vogt, Niro, Scavone, Haller & Niro, Suite 4600, 181 W. Madison, Chicago, IL, 60602, US

(21) Appl. No.: 10/393,375

(22) Filed: Mar. 20, 2003

Related U.S. Application Data
(60) Provisional application No. 60/371,196, filed on Apr. 9, 2002.

(51) Int. Cl. G06F 7/00

(52) U.S. Cl. 707/1

(57) ABSTRACT

A data entry system and method where a hand-held processor such as a PDA is used to enter data concerning a medical operative procedure such as a rhinoplasty procedure at a point of patient contact. Text and graphic templates can be displayed to allow the operator to enter standard patient data as well as specialized data concerning operative maneuvers. Graphic anatomical templates allow the operator to draw in specific anatomical data using various formats and colors. Data from the hand-held processor can be transferred to a desktop or other computer for entry into a larger patient database. Queries can be entered as well as other data manipulation performed on this second database.

This application is related to, and derives priority from, U.S. provisional patent application No. 60/371,196 filed Apr. 9, 2002 and hereby incorporates that application by reference.

### BACKGROUND

1. Field of the Invention

The present invention relates generally to the field of hand-held data entry and more particularly to a hand-held operative database used for rhinoplasty and other medical procedures.

2. Description of the Prior Art

Rhinoplasty is facial plastic surgery performed on the human nose. It is one of the most challenging facial plastic operations to learn and perform because of the dynamic post-operative relationships between the skin-soft tissue envelope and underlying cartilage and bone. It is very important for the physician to document these evolving and dramatic changes through accurate perioperative records that will ultimately influence whether selected operative maneuvers are employed in future procedures. Achieving predictable results in rhinoplasty requires both understanding nasal aesthetics and nasal anatomy and its underlying deformity as well as precise recording of operative maneuvers. Any methods that provide reliable, consistent and meaningful perioperative documentation assist the rhinoplastic surgeon in achieving the goal of superior results. In general, rhinoplasty requires that the user record over 80 specific surgical descriptors.

Prior art methods to record intraoperative surgical maneuvers include dictated operative reports, line anatomic diagrams and text-based data sheets. All too often, the operative note is dictated long after the completion of the procedure when the surgeon cannot exactly recall subtle important operative details, or can only provide a generic description of the procedure. Many times, important adjunctive diagrammatic representation of operative events is omitted. What is needed is a tool that promotes recording of intraoperative maneuvers to enhance the surgeon's appreciation of postoperative results and lead to a better understanding of the outcomes expected in this complex operation.

It is known that computerized rhinoplasty and other medical operative records greatly enhance the ability to query large amounts of text and graphic data significantly diminishing the time required to perform retrospective review of results and collect data on specific intraoperative maneuvers. Prior art methods, however are prone to an inherent reduction in the quality of the data when rhinoplasty records are entered into a computer at a later time. There is a need therefore for a operative data base system and method that allows data to be electronically collected at the point and time of actual patient contact.

### SUMMARY OF THE INVENTION

The present invention relates to a hand-held computer patient database where rhinoplasty or other patient medical data can be collected on a hand-held device at actual points and times of patient contact and optionally later transferred to a second computer such as a desktop computer for entry into a permenant patient database.

Operative procedures can be entered in both text and grapic form into templates contained in the memory of a hand-held or other processor. These templates can receive patient text data as well as contain graphical anatomic diagrams. The operator can enter data into the textual fields either manually or through the use of menus, while graphical data can be drawn in using graphic software or can be selected from standard formats. Text data can contain general patient information and information specific to various procedures. This information can also include standard diagnosis codes and procedure codes.

Normally, a surgeon will draw in graphic data representing the condition of the patient at the time of examination. Different types of graphic data relating to operative maneuvers can be displayed in different colors on the screen. For example, maneuvers relating to incisions, suturing, alloplastic implantation, cartillage grafting or morselization can be displayed in different colors or patterns.

Data in the hand-held processor can then be optionally transferred to a second computer such as a desktop PC running a database program. The power of the database program running on the desktop computer can be used to make queries and other manipulations and searches of the data.

### DESCRIPTION OF THE DRAWINGS

FIG. 1 shows a representative PDA screen display showing an empty graphic template.

FIG. 2 shows linked text display fields containing various information.

FIG. 3 shows automatic menu selection of a diagnosis and linking between diagnosis description and ICD code fields.

FIG. 4 shows entry of data into an operative template that provides standard graphic representation of the nasal cartilaginous and bony skeleton.

FIGS. 5-8 show additional operative templates and data entry similar to those in FIG. 4.

FIG. 9 shows an integrated database display on a desktop computer.

It should be understood that figures and illustrations are provided to facilitate understanding of the invention. The scope of the present invention is not limited to what is shown in the figures.

### DETAILED DESCRIPTION OF THE INVENTION

The present invention relates to a system and method for taking and storing data relating to operative procedures. In particular, examples of the invention relate to rhinoplasty data. Text and graphic templates can be stored on hand-held devices such as personal data assistants (PDAs) so that both descriptive text information and graphic depictions of procedures performed and post-operative conditions can be entered at the time and point of patient contact. This can include a series of menus that can be displayed on the PDA screen. Each menu can allow the direct entry of patient information or point to other menus of graphic templates.

The PDA database can incorporate text descriptors regarding patient demographics, specific operative maneuvers, linked pre-operative diagnosis with ICD codes (International Classification of Diseases), linked operative procedure with CPT codes (Current Procedural Terminology), patient peroperative photodocumentation, and a user modifiable anatomic image representation of operative procedures specific to facial cosmetic and reconstructive surgical procedures.

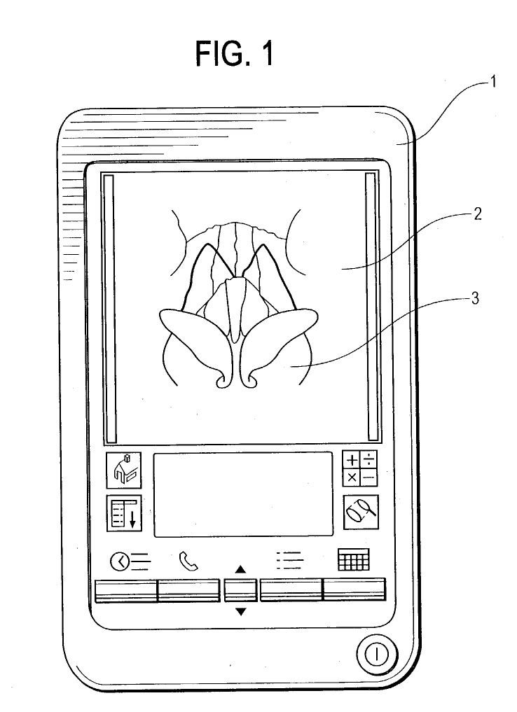

FIG. 1 shows an example of a hand-held personal digital assistant (PDA) 1 such as might be used with the present invention. Here the PDA screen 2 is displaying a blank template 3 of one possible view of human nasal anatomy that is of interest in rhinoplasty. This particular type of template can be filled in graphically during an examination of the patient or shortly thereafter while memory of the patient's condition is fresh in the operator's mind. Complete data entry could involve answering a series of questions on text screens and filling in graphics on other similar graphic template screens.

Information stored on the hand-held computer may then be optionally transferred to a larger computer such as a laptop or desktop PC or other computer. Data may be transferred via a cable connection or wirelessly using radio or infrared methods. The larger computer could then maintain complete patient files with new data being added to older data so that a complete chronological data record could be established.

When the operator wants to enter data about a particular patient the hand-held device, he or she can select either a file in the PDA concerning that patient or open a new file. Because some PDA devices contain only limited memory, one embodiment of the present invention uses the PDA only for entry of new data with the patient's permanent file being located on a larger computer. However, it is within the scope of the present invention to store all data concerning a particular patient on a hand-held computer.

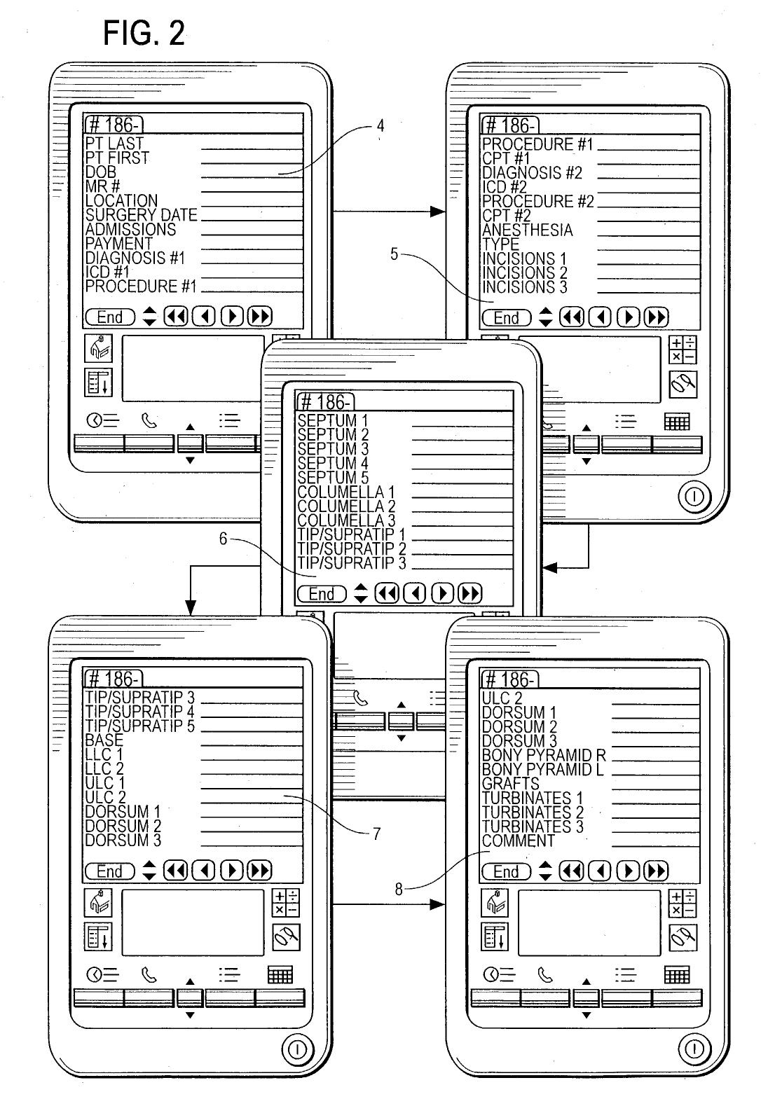

During the course of data entry a series of linked screens can be presented to the operator. FIG. 2 shows such a series of screens. A possible first screen 4 could request general patient information such as name, date of birth, identifying numbers, location, admissions, payment type, diagnosis, procedure and other information about both the patient and the current procedure. Linking screens is optional; all text data can appear on a single scrolled screen.

FIG. 2 shows a linkage between the initial screen 4 and other screens. Each screen that is linked can require more detailed data or can be a continuation of a previous screen. Each screen can also be made scrollable so that more information can be contained on the screen than can be viewed at one time. In this case, the operator can simply scroll the screen by accessing the scroll control key on the PDA.

After general patient information is entered, the operator can next optionally enter a diagnosis. A diagnosis can be chosen from a pull-down menu of different possibilities which causes the chosen dianosis to be automatically entered in the diagnosis field or it can be directly entered. The diagnosis field can be lined to the ICD field so that when an entry which is made in the diagnosis field, it can have its corresponding ICD numerical code automatically entered in the ICD field. In general, more than one diagnosis-ICD linkage is possible. Thus, the screens can generally provide for diagnosis #1, diagnosis #2, etc. with corresponding ICD #1, ICD #2 and so on 5. The same mechanism can be applied to the procedure text description and the CPT code. Entering or choosing a procedure can cause the correct CPT code to be automatically entered in the CPT field.

Additional fields can specifically address the anatomic regions operated in rhinoplasty, and the operator can select from pull-down menus a variety of operative maneuvers 6-8.

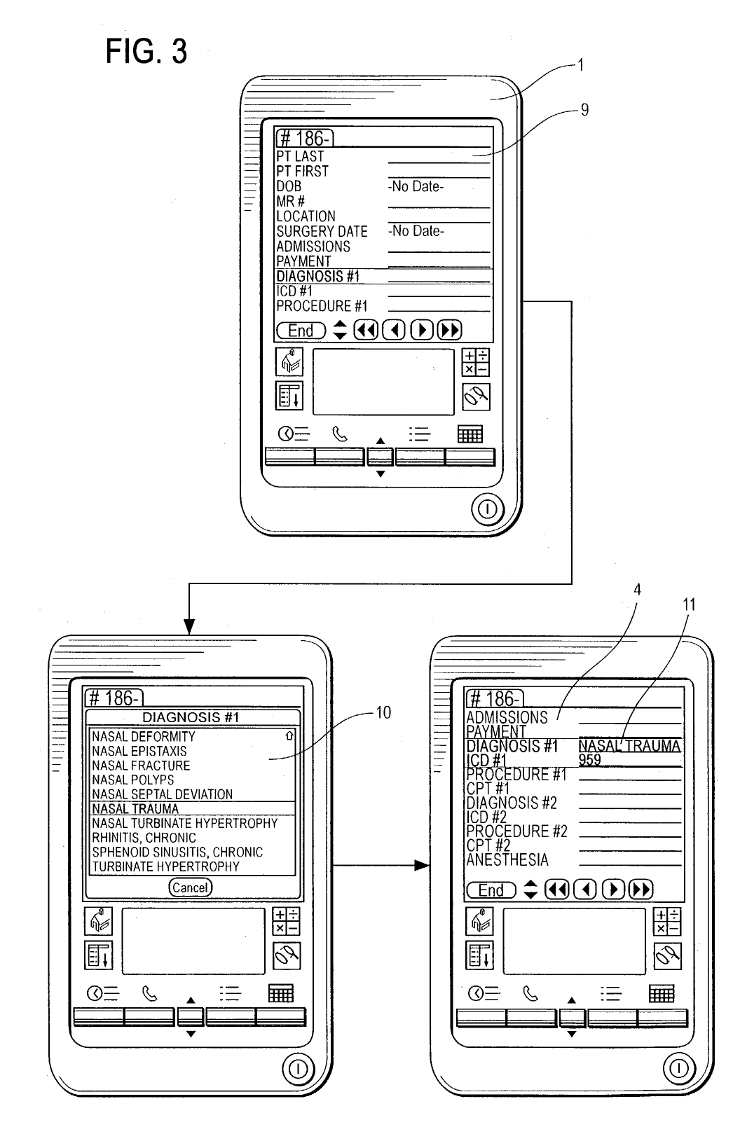

A particular example of the data entry procedure just described can be seen in FIG. 3. Here, on the screen depicted in the upper part of the figure, the field “Diagnosis #1” is shown highlighted 9 on the screen of the PDA 1. When the operator selects that line, a pull-down menu 10 (seen in the lower left screen) allows a choice of diagnosis. If the line “Nasal Trauma” is selected, the pull-down menu can disappear leaving the diagnosis line filled in on the base screen 4. It can be seen that the phrase “Nasal Trauma” has been transferred to the diagnosis line 11 of the base screen. This method of selecting standard diagnosis choices from a menu allows other entries such as ICD code to be automatically entered. It is particularly useful because when linked data is entered this way, there is no possibility of human error such as entering an ICD code that does not match the entered diagnosis. Of course, entry of data by means of pull-down menus is not essential to the functioning of the present invention. Data can be entered by the operator into any field manually or by any other data entry method.

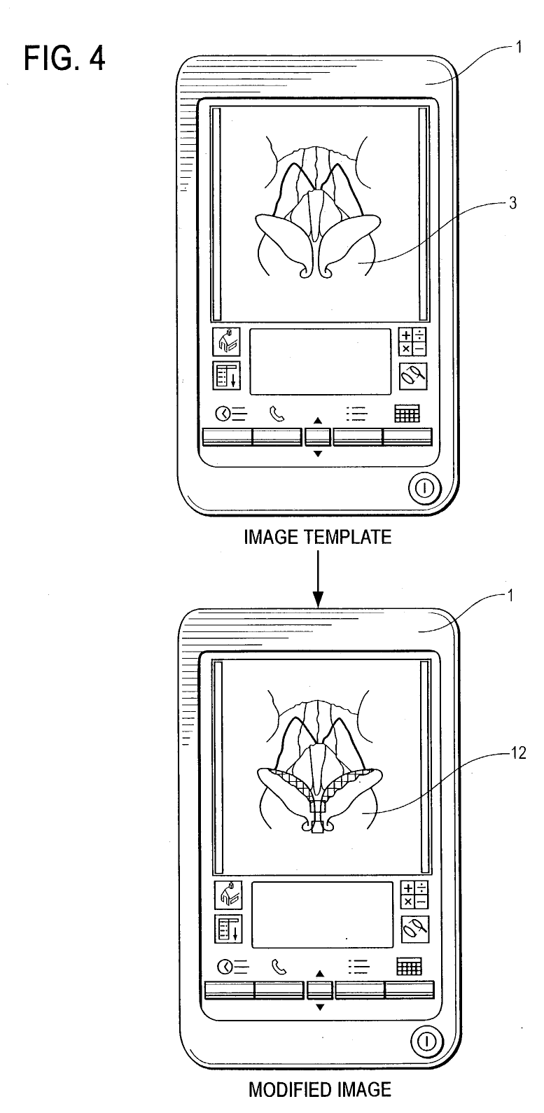

After textual fields are entered (including possible comments), the next step is usually to enter graphic data. FIG. 4 shows an image template 3 on the PDA screen 1 in the upper view. The operator can graphically enter specifics concerning the patient's condition or the operative procedure by either drawing onto the template directly or by selecting pre-stored operative graphic templates. The purpose of this step is to store a lasting graphical description of the patient's condition or of the results of an operative procedure. Chronological sequences of such stored graphics can be extremely valuable to access a patient's progress after a particular operative maneuver.

Different types of graphic data relating to operative maneuvers can be displayed in different colors on the screen. For example, maneuvers relating to incisions, suturing, alloplastic implantation, cartillage grafting or morselization can be displayed in different colors or patterns.

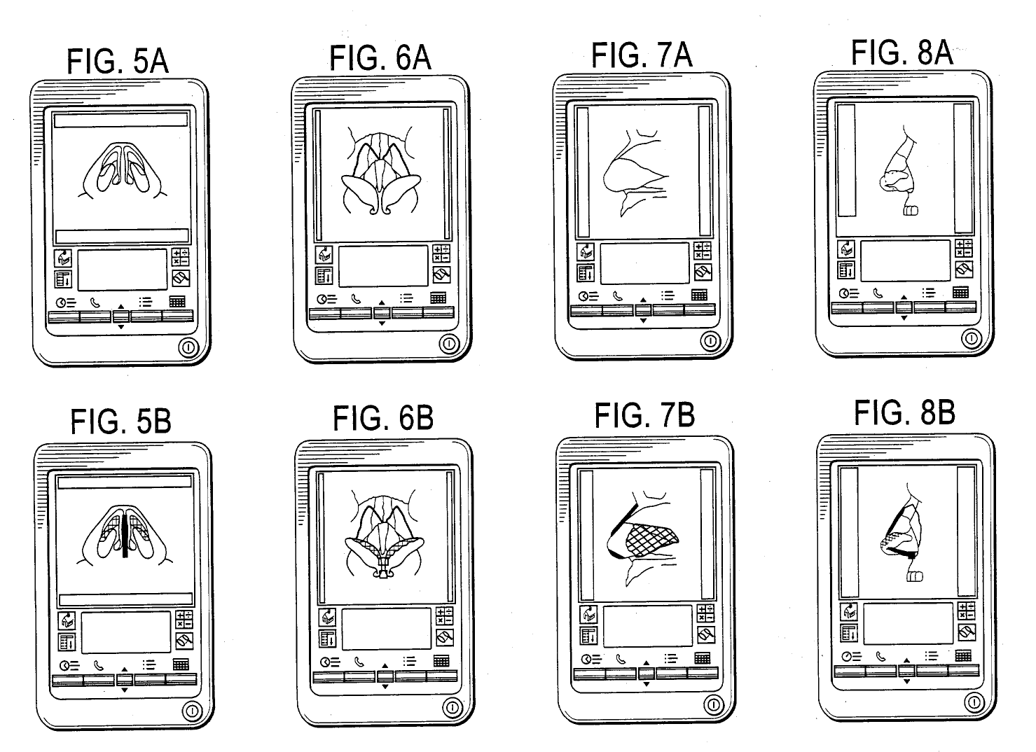

FIGS. 5-8 (in groups such as FIG. 5A and FIG. 5B, etc.) show four different possible rhinoplasty anatomic views of the nasal bony and cartilaginous skeleton. In the upper figure of each group, an empty template of a particular type is shown. In the corresponding lower figure, examples of drawn-in templates are shown. In general, the surgeon or operator can direcly draw onto the template using any desired legend or convention to clearly indcate where incisions, excisions, graft placement-or sutures were made.

While any type of hand-held device running any software is within the scope of the present invention. A particular example is a Palm Vx or a Sony CLIE hand-held unit with 8 or 16 MB of RAM memory running Palm OS v.4.11s, Pendragon Forms v. 3.2 for text data and TealPaint v. 4.95 or CLIE paint v. 1.04 for graphics.

Additional security can be provided by using file encryption programs known in the art examples of which could be PDASecure or GoldSecure manufactured by Trust Digital LLC.

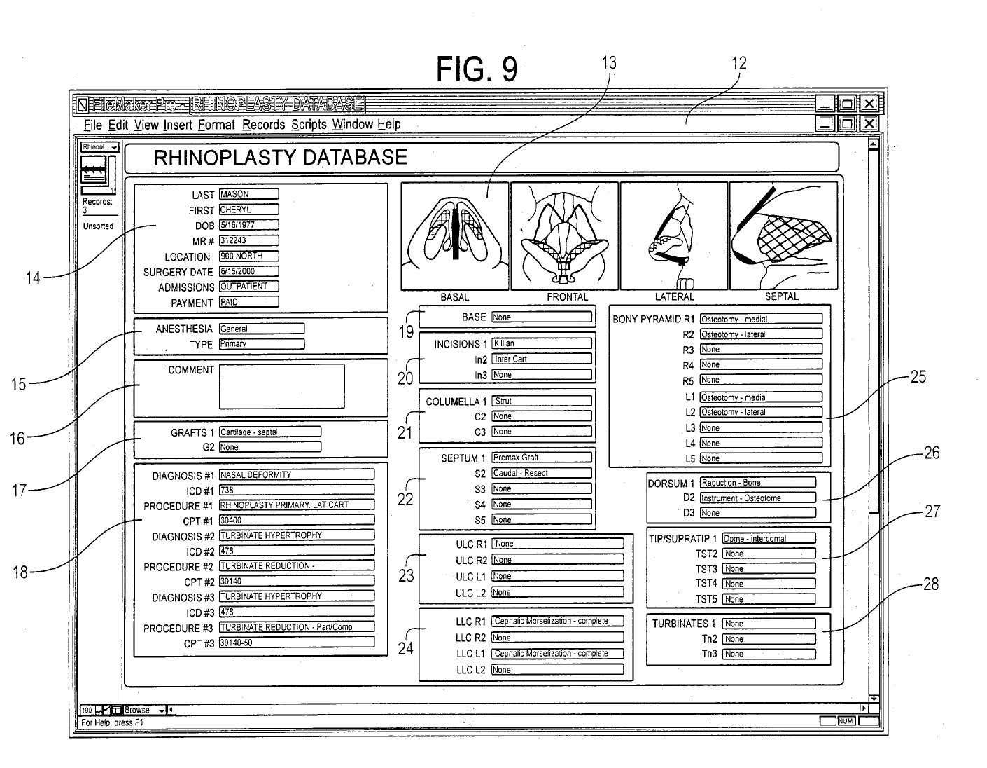

Once hand-held data has been collected, it can optionally be uploaded to a larger computer. In particular, data can be uploaded to a database program running on a PC computer such as Microsoft Access. FIG. 9 shows a spreadsheet-like display screen 12 showing data taken for a particular patient with a particular date of surgery. Each different type of data can be displayed in a separate box. Patient identification data 14 is usually of first interest and can be displayed in the upper left hand corner. Running down the page, data concerning anesthesia 15, general comments 16, grafts 17 and various diagnosis and procedures 18 can be seen. In this example, a hypothetical patient Cheryl Mason 14 underwent a procedure where general anesthesia was used 15 to receive a septal cartilage graft 17. The general diagnosis involved a nasal deformity with ICD code 738 underwent a rhinoplasty procedure with CPT code 30400 18. There were also additional diagnosis and procedures.

Graphics show basal, frontal, lateral and septal sections 13 with graphics drawn onto the base template by the surgeon. On the right of the screen, other, more specific, fields can be displayed 19-20. Among these can be a record of incisions 20, columella 21 septum 22, dorsum 26 and other specialized fields.

A desktop type of computer or other computer database can provide query-capable format where individual and collective patient data can be searched for a variety of descriptors pertaining to operative maneuvers performed. By means of example, all patient data could be searched within the fields “tip/supratip” and “LLC” (lower lateral cartilage) for the term “Dome-interdomal suture” and “Cephalic Excision-complete” respectively. The result would be files on those patients who had undergone both procedures. In another example, database queries could be used to locate patients with a variety of grafting materials and other anatomic specific procedures.

Various descriptions, examples and figures have been used herein to illustrate the present invention. It will be appreciated by one skilled in the art that numerous changes and variations are possible without deviating from the spirit of the invention. All such changes and variations are within the scope of the present invention.

I claim:

1. A hand-held database system for use in recording operative procedures comprising:
a hand-held processor with a memory;
a plurality of templates representing text data or anatomic diagrams stored in said memory;
a software procedure running on said hand-held processor to permit adding to said templates information concerning an operative maneuver.

2. The hand-held database system of claim 1 wherein said templates are for use in facial plastic reconstructive surgery.

3. The hand-held database system of claim 1 wherein at least one of said templates is a graphic image template.

4. The hand-held database system of claim 3 wherein said software is adapted to allow at least one operative maneuver to be graphically entered onto said graphic image template.

5. The hand-held database of claim 4 wherein said software is adapted to allow a plurality of operative maneuvers to be graphically entered onto different graphic image templates.

6. The hand-held database system of claim 5 wherein said software is adapted to allow operative maneuvers relating to incisions, suturing, alloplastic implantation, cartillage grafting or morselization to be displayed in different colors or patterns.

7. The hand-held database system of claim 1 wherein said text data contains at least a patient name and a list of operative maneuvers.

8. The hand-held database system of claim 1 where said software is adapted to allow said text data to be entered via menus.

9. The hand-held database system of claim 8 wherein said software is adapted to allow entering a diagnosis from a menu so as to cause an ICD code to be automatically entered in an ICD field.

10. The hand-held database system of claim 8 wherein said software is adapted to allow entering a procedure from a menu so as to cause a CPT code to be automatically entered in a CPT field.

11. The hand-held database system of claim 1 wherein said software is adapted to allow data entered into said hand-held processor to be transferred to another computer.

12. A database system for use in recording operative procedures comprising:
a hand-held processor having a first database;
said first database including text and image templates adapted to permit a user to enter patient contact data relating to surgical procedures;
personal computer having a second database, said second database including image data and patient records;
software adapted to transfer said patient contact data from said first database to said second database, said second database being updated by transferred data from said first database.

13. The database system of claim 12 wherein said second database contains a patient pre-operative photograph.

14. The database system of claim 12 wherein said first database includes a software procedure running on said hand-held processor to permit adding to said image templates an operative maneuver performed.

15. The database system of claim 12 wherein said image templates of said first database are transferrable to said second database.

16. The database system of claim 12 including a display means for displaying said image templates in said second database.

17. The database system of claim 16 wherein incisions, suturing, alloplastic implatation, cartilage grafting and morselization are displayed in different colors or patterns.

18. A method of collecting post-operative patient data into a database comprising the steps of:
providing a hand-held computer with displayable text or image templates for entering patient data;
collecting patient data at a point of patient contact by filling in at least one of said templates with text or graphic data relating to at least one operative maneuver;
transferring said patient data from said hand-held computer to another computer.

19. The method of claim 18 further comprising the step of displaying said templates with said patient data on a screen.

20. The method of claim 19 wherein operative maneuvers relating to incisions, suturing, alloplastic implantation, cartillage grafting or morselization are displayed in different colors or patterns.

21. The method of claim 18 wherein entering a diagnosis into one of said templates causes an ICD code to be automatically entered.

22. The method of claim 18 wherein entering a procedure into one of said templates causes a CPT code to be automatically entered.

23. The method of claim 18 further comprising the step of entering at least one data query against said database.

24. The method of claim 18 wherein data from said templates is displayed as a spreadsheet.

25. A hand-held database system for use in recording operative procedures comprising:
a processor means for presenting templates to a user, said templates each representing text or anatomic diagrams; means for adding information to said templates concerning an operative maneuver.

26. The hand-held database system of claim 25 wherein said operative maneuver is a rhinoplasty maneuver.
